(19) United States
(12) Patent Application Publication
(10) Pub. No.: US 2015/0173542 A1
(43) Pub. Date: Jun. 25, 2015

(54) MULTIFUNCTIONAL TABLEWARE FOR MELTING FOOD

(71) Applicant: CHAUN-CHOUNG TECHNOLOGY CORP., NEW TAIPEI CITY (TW)

(72) Inventors: Loren HUANG, New Taipei City (TW); Meggy CHU, New Taipei City (TW)

(73) Assignee: CHAUN-CHOUNG TECHNOLOGY CORP., NEW TAIPEI CITY (TW)

(21) Appl. No.: 14/180,033

(22) Filed: Feb. 13, 2014

(30) Foreign Application Priority Data
Dec. 19, 2013 (TW) 102224018

(51) Int. Cl. A47G 21/00; B26B 3/02; A47G 21/04

(52) U.S. Cl. CPC A47G 21/007; A47G 21/04; B26B 3/02; A47G 2021/008

(57) ABSTRACT

Tableware for melting food is disclosed. The tableware includes a metal body having a vacuum chamber, and the metal body is formed with a first handling portion and a second handling portion communicated with the vacuum chamber at two ends. A circulating fluid of low vaporization temperature is filled in the vacuum chamber, wherein when one of the first handling portion and the second handling portion is held by user and the other one of the first handling portion or and the second handling portion touches. Thus heat conducted from the tableware will melt food for cutting easily.

### BACKGROUND OF THE INVENTION

1. Field of the Invention

The present invention generally relates to dining utensils and, in particular to multifunctional tableware for melting food.

2. Description of Related Art

Tableware is an indispensable utensil for everyone eating food. Especially when food is of large amount, such as a bucket of ice cream, a piece of butter or cheese, this kind of food requires taking many times such that an ice cream scoop or a butter knife is needed for users sharing food.

However, those ice cream, butter or cheese is usually taken out from a refrigerator or a freezer, in which food is hard and is not easy to cut for sharing. Thus users must take utensils such as an ice cream scoop or a butter knife, and put forth his strength to dig or cut food while eating. By this way, it is time consuming and a great effort is required. Besides, food experienced digging or cutting is usually with poor appearances.

Moreover, users can put the ice cream, butter or cheese at a room temperature for a period of time, and then the food will melt slightly for cutting easily. However, this sharing way is not good for later food preservation when it is not finished, because the flavor and fresh of the food will be affected, and it is not good for eating.

Furthermore, because living space of people nowadays is more less, then how to design multifunctional utensils of life for saving storage space will save troubles of diverse purchase.

In view of the above drawbacks, the Inventor proposes the present invention based on his expert knowledge and elaborate researches in order to solve the problems of prior art.

### SUMMARY OF THE INVENTION

Accordingly, an object of the present invention is to provide multifunctional tableware for melting food, users can optionally hold any end of the tableware and melt food through heat conduction for cutting food.

In order to achieve the object mentioned above, the present invention provides multifunctional tableware for melting food. The tableware comprises a metal body having a vacuum chamber, and one end of the metal body is formed as a first handling portion and the other end is formed as a second handling portion. The first handling portion and the second handling portion are communicated with the vacuum chamber. A circulating fluid of low vaporization temperature is filled in the vacuum chamber; wherein when one of the first handling portion and the second handling portion is held by user and the other one of the first handling portion or and the second handling portion touches. The circulating fluid is vaporized by absorbing external energy from an end of the metal body held by users, and the vaporized circulating fluid flows to the other end of the metal body for touching food and releases energy for melting food. The circulating fluid will return to the end of the metal body held by users through the circulation media after releasing energy.

Another object of the present invention is to provide multifunctional tableware for melting food, the first handling portion and the second handling portion can optionally be embodied as a knife, a butter knife, an ice cream spoon, a digging spoon or a spoon, and shapes and functions of the tableware can be varied and combined as demands.

Comparing to the prior art, the multifunctional tableware for melting food of the present invention is filled with a circulating fluid of low vaporization temperature in the vacuum chamber. Users can optionally hold an end of the tableware (the first handling portion or the second handling portion), and then the circulating fluid will be vaporized by absorbing the users' temperature for transferring the heat quickly to the other end and releasing heat for heating food. Because the tableware of the present invention transferring heat by using the vaporization of the circulating fluid, and the metal body has a vacuum chamber for transferring heat quickly and heating food in time. Moreover, the first handling portion or the second handling portion of the tableware can optionally be embodied as a knife, a butter knife, an ice cream spoon, a digging spoon or a spoon, and shapes and functions of the tableware can be varied and combined as demands. Thus storage space will be saved and diversity purchasing can be avoided.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of a first embodiment of multifunctional tableware for melting food of the present invention;

FIG. 2 is another perspective schematic view of a first embodiment of multifunctional tableware for melting food of the present invention;

FIG. 3 is a cross sectional view of a first embodiment of multifunctional tableware for melting food of the present invention;

FIG. 4 is another cross sectional view of a first embodiment of multifunctional tableware for melting food of the present invention;

FIG. 5 is a schematic view illustrating operation of a first embodiment of multifunctional tableware for melting food according to the present invention;

FIG. 6 is another schematic view illustrating operation of a first embodiment of multifunctional tableware for melting food according to the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

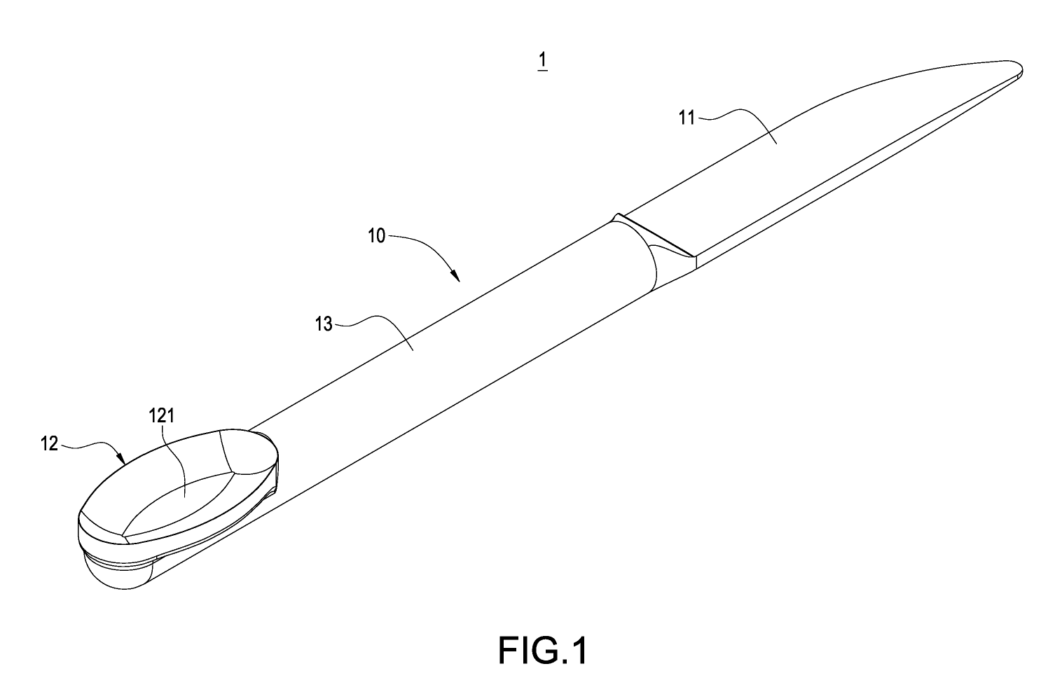

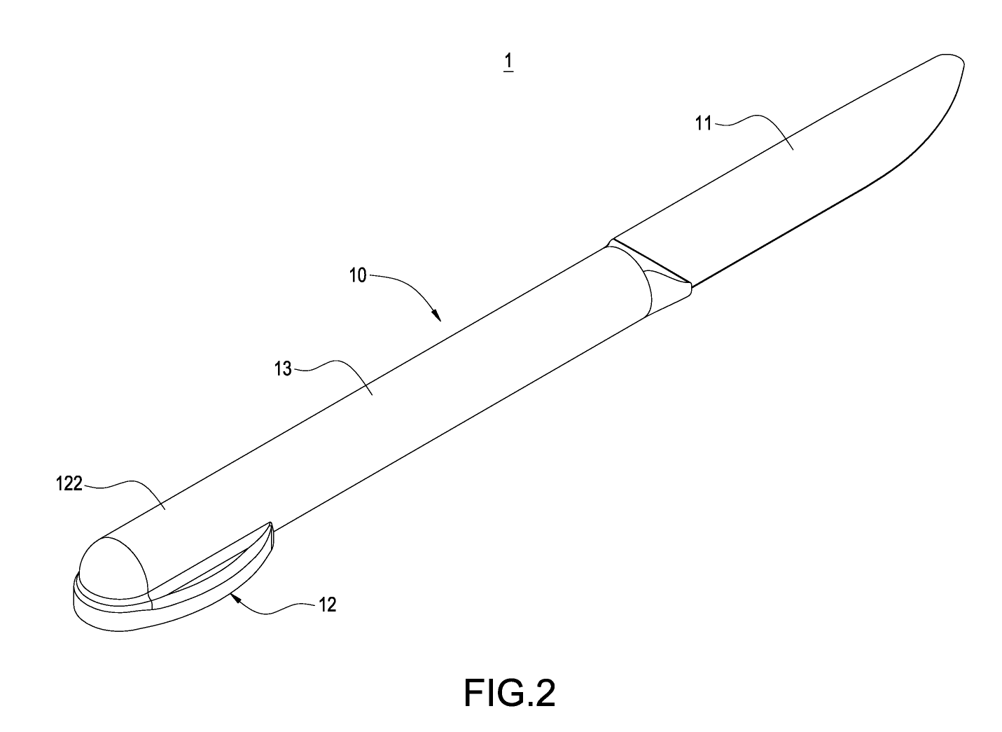

Please refer to FIG. 1 to FIG. 4, which depict two perspective schematic view and a cross sectional view of a first embodiment of multifunctional tableware for melting food of the present invention. The present invention provides multifunctional tableware 1 for melting food. The multifunctional tableware 1 includes a metal body 10, a circulating fluid 20 of low vaporization temperature and a circulation media 30. The circulating fluid 20 and the low vaporization temperature and a circulation media 30 are disposed in the metal body 10 for constructing the multifunctional tableware 1 for melting food.

The metal body 10 is made of stainless or copper. The metal body 10 has a vacuum chamber 100, and the vacuum chamber 100 is used for transmitting the energy quickly. One end of the metal body 10 is formed as a first handling portion 11, and the other end is formed as a second handling portion 12. Besides, the first handling portion 11 and the second handling portion 12 are communicated with the vacuum chamber 100. One end of the vacuum chamber 100 is the first handling portion 11, and the other end is the second handling portion 12. In an embodiment of the present invention, the metal body 10 further forms a connection portion 13 between the first handling portion 11 and the second handling portion 12.

The circulating fluid 20 of low vaporization temperature is filled in the vacuum chamber 100. The circulating fluid 20 is fluid of a low vaporization temperature. Preferably, the circulating fluid 20 is water or ethanol. In real practice, the circulating fluid 20 is liquid at a low temperature. On the other hand, the circulating fluid 20 will be vaporized at a high temperature after absorbing heat.

Furthermore, the circulation media 30 is implemented with sintered metal powder, copper wire or metal net. The circulation media 30 is disposed on an inner wall of the vacuum chamber 100. When one of the first handling portion 11 and the second handling portion 12 is held by user and the other one of the first handling portion 11 or and the second handling portion 12 touches. The circulating fluid 20 is vaporized by absorbing external energy from an end of the metal body 10 held by users. As the circulating fluid 20 can be vaporized at a lower temperature, the circulating fluid 20 absorbs external heat from the first handling portion 11. The vaporized circulating fluid 20 flows to the other end of the metal body 10 for touching food and releases energy for melting the food. And the circulating fluid 20 will return to the end held by users of the metal body 10 through the circulation media 30 after releasing energy.

In an embodiment of the present invention, the connection portion 13 is configured in a tube shape. However, in real practice, the configuration of the first handling portion 11 and the second handling portion 12 could be varied and combined as demands, and the tableware 1 is not limited for any purpose. Besides, the first handling portion 11 and the second handling portion 12 are the same kind or different kinds of dining utensil. For example, the first handling portion 11 and the second handling portion 12 can be embodied as butter knifes or digging spoons; or the first handling portion 11 can be embodied as a butter knife, and the second handling portion 12 can be embodied as a digging spoon.

It is worth notice that when one of the first handling portion 11 and the second handling portion 12 is embodied as a digging spoon (here the second handling portion 12 will be described as a digging spoon), the digging spoon (the second handling portion 12) has a first surface 121 touching food and a second surface 122 oppositely. Preferably, the digging spoon is gradually expanded from the second surface 122 towards the first surface 121 for connecting with the first surface 121. In other words, in a cross sectional view of the digging spoon, the width of the first surface 121 is wider than the width of the second surface 122. Moreover, the second surface 122 is extended smoothly and formed from the connection portion 13. The shape of the digging spoon is helpful for circulating the circulating fluid 20.

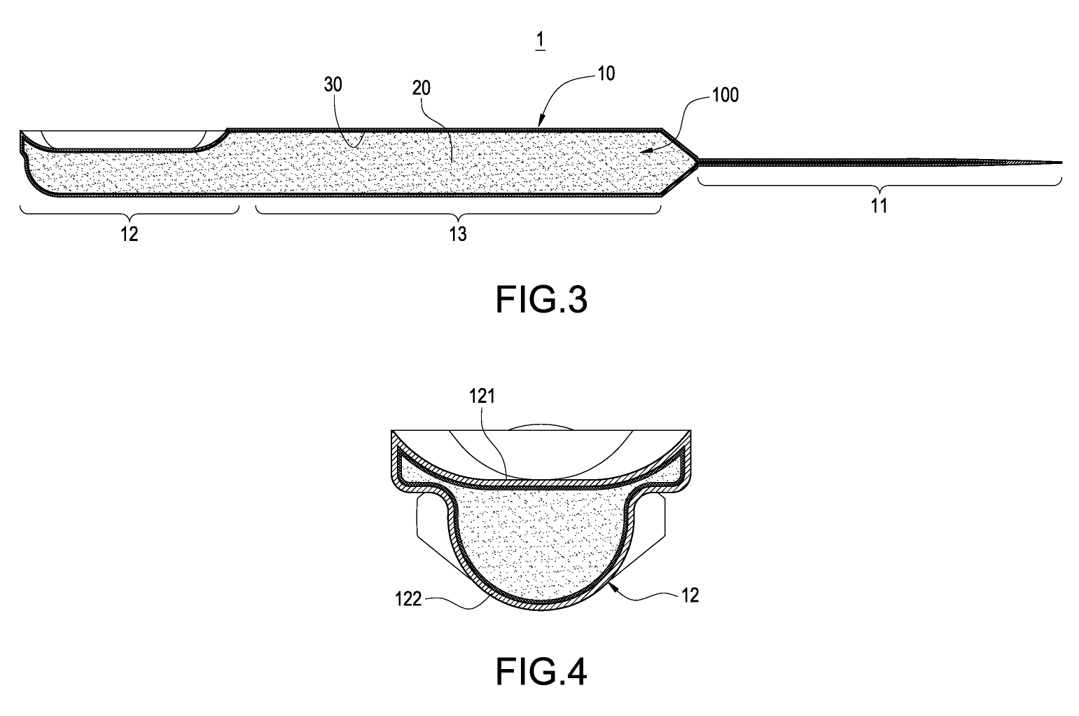

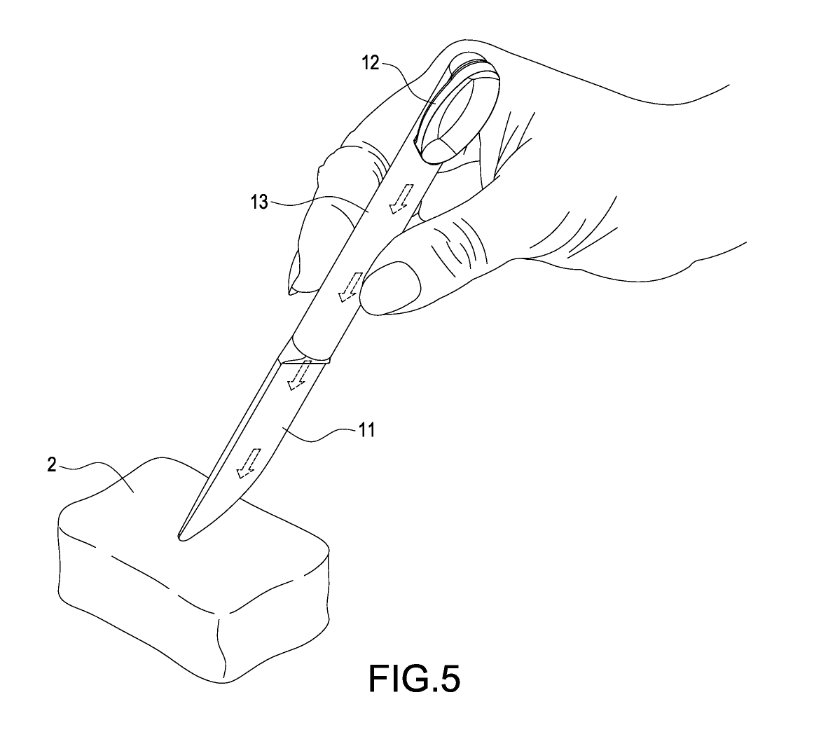

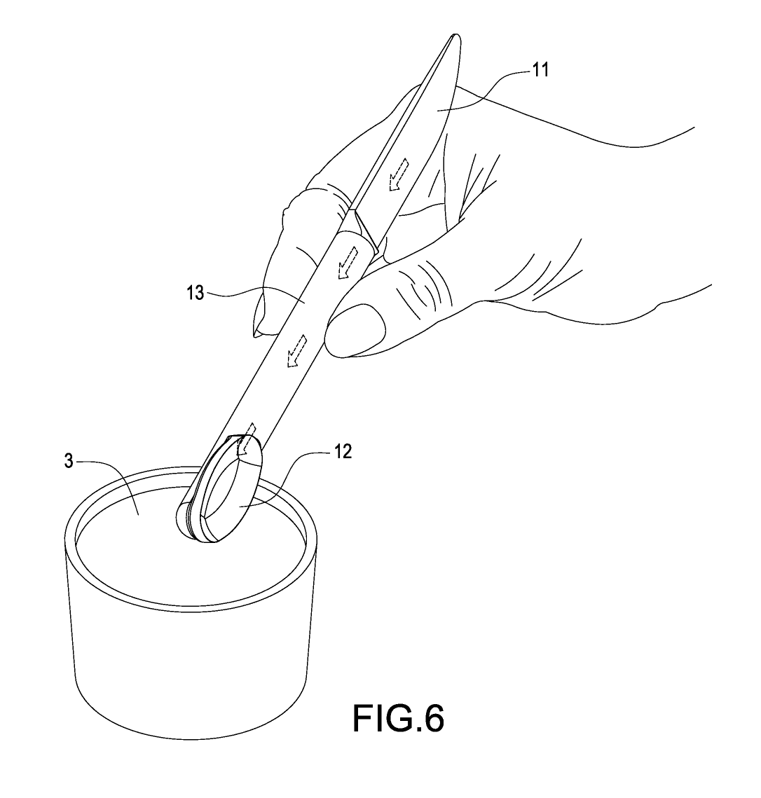

Please also refer to FIG. 5 and FIG. 6, which depict a schematic view illustrating operation of multifunctional tableware for melting food according to the present invention. In the present invention, the first handling portion 11 of the tableware 1 is a butter knife and the second portion 11 is a digging spoon. In the FIG. 3, users hold an end of the second portion 12 (and the connection portion 13), and the circulating fluid 20 of the second portion 11 absorbs the user's body temperature for vaporization. Then the vaporized circulating fluid 20 will flow to the second portion 11 of low temperature. Finally, the vaporized circulating fluid 20 releases energy at the second portion 11 and change to liquid circulating fluid 20, and then the releasing energy will melt food (butter buck 2). When the first handling portion 11 of a high temperature touching the butter buck 2, the butter buck 2 will be melt. Thus users can cut the butter buck 2 easily.

Moreover, the circulating fluid 20 at the first handling portion 11 will return to the second handling portion 12 through the circulation media 30 after releasing energy. In more detail, when the circulating fluid 20 returns to the second handling portion 12 through the circulation media 30, the liquid circulating fluid 20 flows back to the connection portion 13 and the second handling portion 12 along the inner wall of the vacuum chamber 100 through the circulation media 30.

On the other hand, please refer to FIG. 4, users can optionally hold the first handling portion 11 (and the connection portion 13), and the circulating fluid 20 in an end of the first handling portion 11 (and the connection portion 13) absorbs the users' temperature for vaporization. Then the vaporized circulating fluid 20 flows to the second portion 12 at a low temperature and releases energy for melting food, ex. ice cream 3, in the second portion 12. In this way, users can share the ice cream 3 conveniently.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A multifunctional tableware for melting food, comprising:
a metal body having a vacuum chamber, one end of the metal body formed as a first handling portion and the other end formed as a second handling portion, wherein the first handling portion and the second handling portion are communicated with the vacuum chamber;
a circulating fluid of low vaporization temperature filled in the vacuum chamber;
a circulation media disposed on an inner wall of the vacuum chamber;
wherein when one of the first handling portion and the second handling portion is held by user and the other one of the first handling portion or and the second handling portion touches, the circulating fluid will be vaporized by absorbing external energy from an end of the metal body held by users, and the vaporized circulating fluid flows to the other end of the metal body for touching food and releases energy for melting food, and the circulating fluid returns to the end of the metal body held by users through the circulation media after releasing energy.

2. The tableware according to claim 1, wherein the metal body further forms a connection portion between the first handling portion and the second handling portion.

3. The tableware according to claim 1, wherein the metal body is made of stainless or copper, and the circulation media is sintered metal powder, copper wire or metal net, and the circulating fluid is water or ethanol.

4. The tableware according to claim 1, wherein the first handling portion and the second handling portion are the same kind of dining utensil.

5. The tableware according to claim 4, wherein the first handling portion and the second handling portion are butter knifes.

6. The tableware according to claim 4, wherein the first handling portion and the second handling portion are digging spoons.

7. The tableware according to claim 1, wherein the first handling portion and the second handling portion are different kinds of dining utensils.

8. The tableware according to claim 7, wherein the first handling portion is a butter knife, and the second handling portion is a digging spoon.

9. The tableware according to claim 2, wherein one of the first handling portion and the second handling portion is a digging spoon, and the digging spoon has a first surface touching food and a second surface oppositely, the digging spoon is gradually expanded from the second surface towards the first surface for connecting with the first surface.

10. The tableware according to claim 9, wherein the second surface is extended smoothly and formed from the connection portion.
